(19) United States
(12) Patent Application Publication
(10) Pub. No.: US 2025/0007588 A1
(43) Pub. Date: Jan. 2, 2025

(54) REPORTING SENSING BEAMS AND ASSOCIATION WITH TRANSMISSION BEAMS FOR LBT

(71) Applicant: Lenovo (Singapore) Pte. Ltd., New Tech Park (SG)

(72) Inventors: Ankit Bhamri, Rödermark (DE); Alexander Golitschek Edler von Elbwart, Darmstadt (DE); Karthikeyan Ganesan, Kronberg im Taunus (DE); Ali Ramadan Ali, Kraiburg am Inn (DE)

(21) Appl. No.: 18/695,321

(22) PCT Filed: Sep. 26, 2022
(86) PCT No.: PCT/IB2022/059147

§ 371 Date: Mar. 25, 2024

Related U.S. Application Data
(60) Provisional application No. 63/248,000, filed on Sep. 24, 2021.

(51) Int. Cl. H04B 7/06; H04W 74/00; H04W 74/0808

(52) U.S. Cl. CPC H04B 7/0695; H04W 74/006; H04W 74/0808

(57) ABSTRACT

Apparatuses, methods, and systems are disclosed for reporting sensing beams and association with transmission beams for LBT. An apparatus (300) includes a processor (305) and a memory (310) coupled with the processor (305). The processor (305) is configured to report at least one UL transmission beam and at least one sensing beam that can be used to perform LBT prior to transmitting on the at least one UL transmission beam. The processor (305) is configured to indicate a relationship between the at least one UL transmission beam and the at least one sensing beam via TCI, SRI, beam corresponding, or some combination thereof. The processor (305) is configured to indicate a UL transmission beam via TCI, SRI, beam correspondence, or some combination thereof and determine a corresponding at least one sensing beam to perform LBT.

### CROSS REFERENCE TO RELATED APPLICATIONS

This application claims the benefit of United States Provisional Patent Application No. 63/248,000, entitled “REPORTING SENSING BEAMS AND ASSOCIATION WITH TRANSMISSION BEAMS FOR LBT” and filed on Sep. 24, 2021, for Ankit Bhamri, et al., which is incorporated herein by reference.

### FIELD

The subject matter disclosed herein relates generally to wireless communications and more particularly relates to reporting sensing beams and association with transmission beams for listen before talk (“LBT”).

### BACKGROUND

In wireless networks, there is a relationship/association between transmission beams and sensing beams for performing LBT-based channel access mechanism.

### BRIEF SUMMARY

Disclosed are solutions for reporting sensing beams and association with transmission beams for LBT. The solutions may be implemented by apparatus, systems, methods, or computer program products.

In one embodiment, a first apparatus includes a processor and a memory coupled with the processor. In one embodiment, the processor is configured to cause the apparatus to report at least one UL transmission beam and at least one sensing beam that can be used to perform LBT prior to transmitting on the at least one UL transmission beam, according to a first configuration received from a network. In one embodiment, the processor is configured to cause the apparatus to indicate a relationship between the reported at least one UL transmission beam and the reported at least one sensing beam via TCI, SRI, beam corresponding, or some combination thereof, according to a second configuration received from the network. In one embodiment, the processor is configured to cause the apparatus to indicate a UL transmission beam via TCI, SRI, beam correspondence, or some combination thereof and determine a corresponding at least one sensing beam, based on the second configuration, to perform LBT, according to a third configuration received from the network.

In one embodiment, a first method reports at least one UL transmission beam and at least one sensing beam that can be used to perform LBT prior to transmitting on the at least one UL transmission beam, according to a first configuration received from a network. In one embodiment, the first method indicates a relationship between the reported at least one UL transmission beam and the reported at least one sensing beam via TCI, SRI, beam corresponding, or some combination thereof, according to a second configuration received from the network. In one embodiment, the first method indicates a UL transmission beam via TCI, SRI, beam correspondence, or some combination thereof and determine a corresponding at least one sensing beam, based on the second configuration, to perform LBT, according to a third configuration received from the network.

In one embodiment, a second apparatus includes a processor and a memory coupled with the processor. In one embodiment, the processor is configured to cause the apparatus to receive, from a UE, a report of at least one UL transmission beam and at least one sensing beam that can be used to perform LBT prior to transmitting on the at least one UL transmission beam, according to a first configuration. In one embodiment, the processor is configured to cause the apparatus to receive, from the UE, an indication of a relationship between the reported at least one UL transmission beam and the reported at least one sensing beam via TCI, SRI, beam corresponding, or some combination thereof, according to a second configuration. In one embodiment, the processor is configured to cause the apparatus to receive, from the UE, an indication of an UL transmission beam via TCI, SRI, beam correspondence, or some combination thereof and determine a corresponding at least one sensing beam, based on the second configuration, to perform LBT, according to a third configuration.

In one embodiment, a second method receives, from a UE, a report of at least one UL transmission beam and at least one sensing beam that can be used to perform LBT prior to transmitting on the at least one UL transmission beam, according to a first configuration. In one embodiment, the second method receives, from the UE, an indication of a relationship between the reported at least one UL transmission beam and the reported at least one sensing beam via TCI, SRI, beam corresponding, or some combination thereof, according to a second configuration. In one embodiment, the second method receives, from the UE, an indication of an UL transmission beam via TCI, SRI, beam correspondence, or some combination thereof and determine a corresponding at least one sensing beam, based on the second configuration, to perform LBT, according to a third configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reporting sensing beams and association with transmission beams for LBT;

FIG. 2 is a diagram illustrating one embodiment of a NR protocol stack;

FIG. 3 is a block diagram illustrating one embodiment of a user equipment apparatus that may be used for reporting sensing beams and association with transmission beams for LBT;

FIG. 4 is a block diagram illustrating one embodiment of a network apparatus that may be used for reporting sensing beams and association with transmission beams for LBT;

FIG. 5 is a flowchart diagram illustrating one embodiment of a method for reporting sensing beams and association with transmission beams for LBT; and

FIG. 6 is a flowchart diagram illustrating one embodiment of a method for reporting sensing beams and association with transmission beams for LBT.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for reporting sensing beams and association with transmission beams for LBT. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-17, there is an on-going discussion on if and how to specify the relationship/association between transmission beams and sensing beams for performing LBT based channel access mechanism. One of the solutions is based on extension of transmission configuration indicator (“TCI”)/quasi co-location (“QCL”) framework to indicate/associate sensing beams corresponding to the indicated transmission beams. For uplink (“UL”) transmission, gNB can indicate transmission beam either using TCI indication or sounding reference signal (“SRS”) resource indicator (“SRI”) indication or based on downlink (“DL”) reference signal (“RS”) when beam correspondence is supported. In one embodiment, the corresponding sensing beams can be indicated to the user equipment (“UE”) by the gNB for LBT before uplink transmissions. However, an issue is that the gNB is not aware of which sensing beams might be applicable at the UE. The information about sensing beams (for LBT before UL transmission) is only known to the UE. Therefore, in this disclosure, solutions are proposed to facilitate the association/relationship between sensing beams and transmission beams to allow the gNB to indicate such relationship.

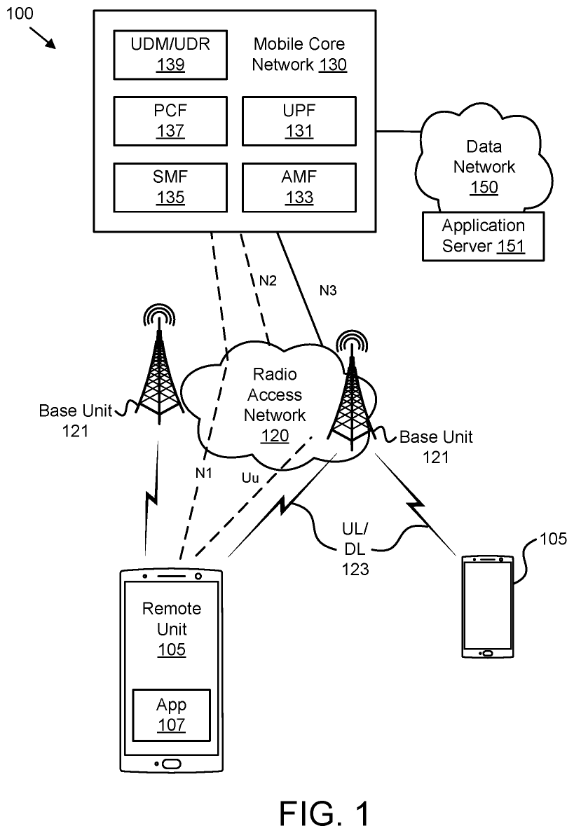

FIG. 1 depicts a wireless communication system 100 for reporting sensing beams and association with transmission beams for LBT, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 UL and DL communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QOS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems for reporting sensing beams and association with transmission beams for LBT.

In this disclosure, enhancements are proposed for the UE reporting framework for reporting sensing beams corresponding to each of the reported UL transmission beams. In one embodiment, this allows the gNB to control and indicate not just the UL transmission beam(s) for physical uplink shared channel (“PUSCH”) and/or physical uplink control channel (“PUCCH”), but also corresponding sensing beams to perform LBT for channel sensing. In one embodiment, this allows to support gNB controlled sensing beam and transmission beam relationship/association indication even for the case when beam correspondence is not supported at the UE.

According to a first embodiment directed to enhanced reporting for sensing beams corresponding to UL transmission (“Tx”) beams, the UE is configured by the network to report at least one sensing beam corresponding to each indicated UL Tx beam. In one implementation, the source RS for the sensing beams could be based on the DL RS resource, where the UE can indicate the DL RS resource ID for indicating the sensing beams corresponding to the UL Tx beams. Example procedures for the UE to determine and report sensing beams corresponding to UL Tx beams are described below:

When UL Tx beams are based on UL RS (e.g., for reporting sensing beams, UE basically uses the DL RS resource ID that are either configured for DL RS measurements or explicitly configured for sensing purpose):
the gNB configures the UE with resources to transmit UL RS such as SRS for determining the best set of UL Tx beams at the gNB.

In some embodiments, the gNB also configures the UE to send a corresponding report indicating “N” sensing beams corresponding to each of the UL Tx beams (UL RS resource ID):
In one example where N=1, only a single sensing beam is indicated, and the single sensing beam covers the entire UL Tx beam;
In an alternative implementation where N=2, a first indicated sensing beam is a narrow beam covering the UL Tx beam and a second sensing beam has beamwidth wider than the UL Tx beam. The ratio of the second beam width to UL Tx beam width can be (pre-)configured by the network as double, triple, quadruple, and so on, of the UL Tx beam or as (pseudo omni-directional);
In another example where N=2, a first indicated sensing beam covers one half of the UL Tx beam and a second sensing beam covers the other half of the UL Tx beam.

In alternate embodiments, the gNB configures the UE to send a corresponding report indicating “N” sensing beams corresponding to a subset of UL Tx beams (e.g., UL RS resource ID) where the gNB measures the signal strength such as reference signal received power (“RSRP”) above a certain e.g., preconfigurable threshold

In this case, the gNB explicitly indicates the UL Tx beams (e.g., UL RS resource IDs) for which the sensing beams are to be reported.

In another implementation, the UE assistance information signaled via RRC or L2 signaling, such as medium access control element (“MAC CE”), contains one or more sensing resource IDs corresponding to the one or more UL Tx beams semi-statically mapped and a new MAC CE could be defined for this reporting purpose.

When the UL Tx beams are based on DL RS (e.g., when beam correspondence can be assumed):

The gNB configures the UE with resources to receive DL RS such as channel state information (“CSI”)-RS for determining the best set of UL Tx beams at the gNB.

In some embodiments, the gNB also configures the UE to send a corresponding report indicating “N” sensing beams corresponding to each of the UL Tx beams (DL RS resource ID)

In one example where N=0, the gNB doesn't configure the UE to report any sensing beams corresponding to the UL Tx beams, in which case the gNB assumes that the UE can use the same receiving (“Rx”) beam for sensing that is used to receive the corresponding DL RS;

In another example where N=1, a single sensing beam is indicated, and the single sensing beam is required to cover the entire UL Tx beam or a beam wider than the UL Tx beam;

In another example where N=2, a first sensing beam covers one half of the UL Tx beam and a second sensing beam covers the other half of the UL Tx beam;

In an alternative implementation of an example where N=2 a first indicated sensing beam is a narrow beam covering the UL Tx beam and a second sensing beam has a beamwidth wider than the UL Tx beam, the ratio of the second beam width to UL Tx beam width can be (pre-)configured by the network as double, triple, quadruple, or the like, of the UL Tx beam or as pseudo omni-directional.

In alternate embodiments, the gNB configures the UE to send a corresponding report indicating “N” sensing beams corresponding to a subset of UL Tx beams (e.g., UL RS resource ID) where the gNB measures the signal strength, such as RSRP, above a certain e.g., preconfigurable threshold:

In this case, the gNB indicates the UL Tx beams (e.g., UL RS resource IDs) for which the sensing beams are to be reported.

It is noted that the criteria to determine if a sensing beam covers the Tx beam is pre-configured by the network or fixed in specifications. Further, to report sensing beams, the UE is not required to be configured with any RS resources or measurements.

In some embodiments, the reporting configuration for sensing beams could be a separate RRC IE which can semi-statically configure UE to report sensing beams. In some embodiments, the reporting configuration for sensing beams can be configured as a part of UL RS such as SRS configuration. In some embodiments, the reporting configuration for sensing beams can be configured as a part of the DL RS such as CSI-RS measurements/reporting configuration.

In a second embodiment, directed to activation/triggering of reporting for sensing beams corresponding to UL Tx beams, after the UE is configured to report sensing beams to the network, then the gNB can either implicitly or explicitly activate/trigger the reporting configuration.

In one implementation, implicit configuration is used to activate the reporting of sensing beams. In one example, when MAC CE activates a new set of TCI states for UL beam (TCI) indication, the UE can assume that the configured sensing beam reporting is activated. In another example, when a UE is configured to transmit UL RS, then the UE can assume that the configured sensing beam reporting is activated.

In an alternate implementation, explicit configuration is used where a MAC CE is used to activate the reporting of sensing beams by the UE. In an alternate implementation, DCI indication is used to activate the reporting.

In a third embodiment directed to deactivation of reporting for sensing beams corresponding to UL Tx beams, after the UE is activated/triggered to report sensing beams to the network, then the gNB can either implicitly or explicitly deactivate/stop the reporting.

In one implementation, implicit configuration is used to deactivate the reporting of sensing beams. In one example, once the UE has reported at least one sensing beam for each of the activated UL TCI state (UL Tx beam), then the UE can assume to deactivate or stope the reporting of the sensing beam. In another example, the UE can be configured with a number of periods for which the UE is required to report the sensing beams and after the required number is reached, the UE can assume to stop reporting of the sensing beams.

In one implementation, explicit configuration is used where a MAC CE is used to deactivate the reporting of sensing beams by UE. In one implementation, DCI indication is used to deactivate the reporting. In one embodiment, the UE is restricted to report some of the sensing beams, e.g., the UE is configured to deactivate reporting for any wide sensing beams and report only sensing beam(s) that cover the Tx UL beam.

In a fourth embodiment, directed to indication of sensing beams during initial access procedure, after the UE receives one or multiple synchronization signal block (“SSB”) beams from the gNB, then the UE transmits physical random access channel (“PRACH”) on at least one of the PRACH resources associated with the received SSB beam and also the UE can additionally indicate other sensing beams that may correspond to the Rx beams corresponding to the other SSB beams. In one embodiment, this allows the gNB to determine the sensing beams during the initial access procedure itself.

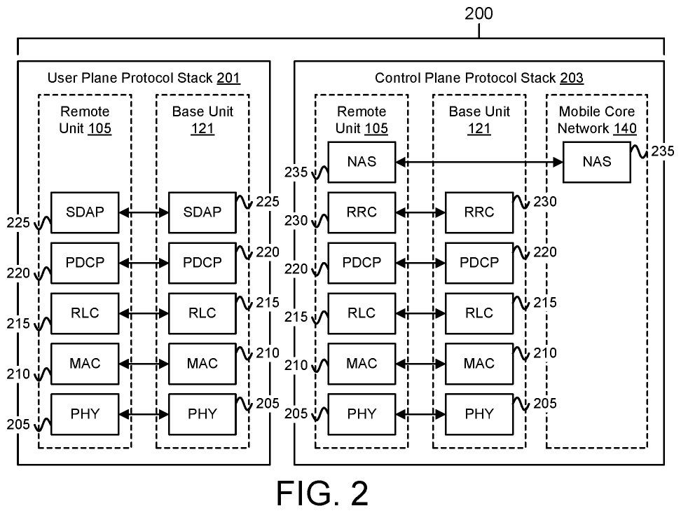

FIG. 2 depicts a NR protocol stack 200, according to embodiments of the disclosure. While FIG. 2 shows the remote unit 105, the base unit 121 and the mobile core network 130, these are representative of a set of UEs interacting with a RAN node and a NF (e.g., AMF) in a core network. As depicted, the protocol stack 200 comprises a User Plane protocol stack 201 and a Control Plane protocol stack 203. The User Plane protocol stack 201 includes a physical (“PHY”) layer 205, a Medium Access Control (“MAC”) sublayer 210, a Radio Link Control (“RLC”) sublayer 215, a Packet Data Convergence Protocol (“PDCP”) sublayer 220, and Service Data Adaptation Protocol (“SDAP”) sublayer 225. The Control Plane protocol stack 203 also includes a physical layer 205, a MAC sublayer 210, a RLC sublayer 215, and a PDCP sublayer 220. The Control Place protocol stack 203 also includes a Radio Resource Control (“RRC”) sublayer 230 and a Non-Access Stratum (“NAS”) layer 235.

The AS protocol stack for the Control Plane protocol stack 203 consists of at least RRC, PDCP, RLC and MAC sublayers, and the physical layer. The AS protocol stack for the User Plane protocol stack 201 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 230 and the NAS layer 235 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 205 offers transport channels to the MAC sublayer 210. The MAC sublayer 210 offers logical channels to the RLC sublayer 215. The RLC sublayer 215 offers RLC channels to the PDCP sublayer 220. The PDCP sublayer 220 offers radio bearers to the SDAP sublayer 225 and/or RRC sublayer 230. The SDAP sublayer 225 offers QoS flows to the mobile core network 130 (e.g., 5GC). The RRC sublayer 230 provides for the addition, modification, and release of Carrier Aggregation and/or Dual Connectivity. The RRC sublayer 230 also manages the establishment, configuration, maintenance, and release of Signaling Radio Bearers (“SRBs”) and Data Radio Bearers (“DRBs”). In certain embodiments, an RRC entity functions for detection of and recovery from radio link failure.

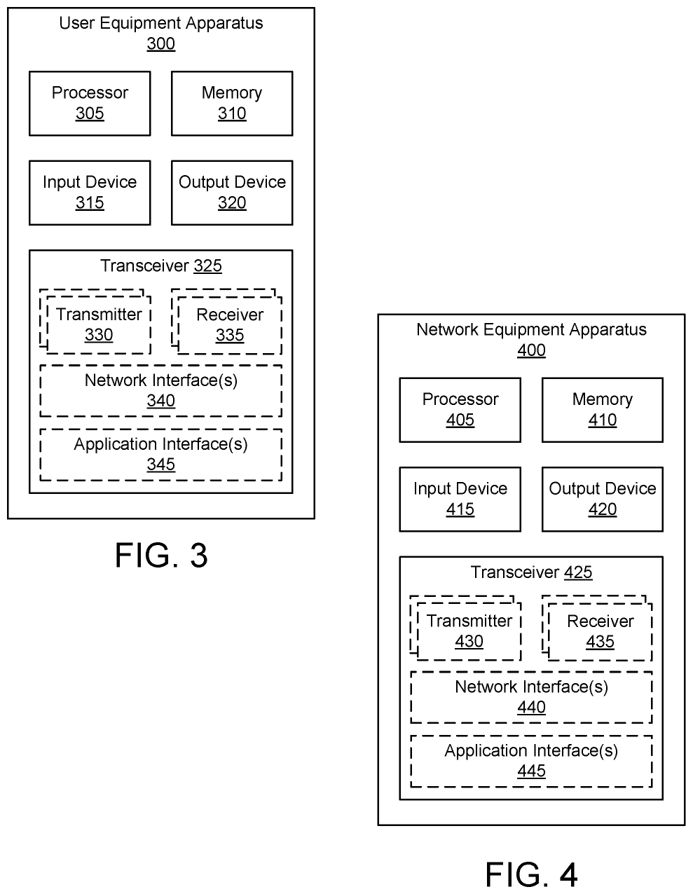

FIG. 3 depicts a user equipment apparatus 300 that may be used for reporting sensing beams and association with transmission beams for LBT, according to embodiments of the disclosure. In various embodiments, the user equipment apparatus 300 is used to implement one or more of the solutions described above. The user equipment apparatus 300 may be one embodiment of a UE, such as the remote unit 105 and/or the UE 205, as described above. Furthermore, the user equipment apparatus 300 may include a processor 305, a memory 310, an input device 315, an output device 320, and a transceiver 325. In some embodiments, the input device 315 and the output device 320 are combined into a single device, such as a touchscreen. In certain embodiments, the user equipment apparatus 300 may not include any input device 315 and/or output device 320. In various embodiments, the user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more base units 121. Additionally, the transceiver 325 may support at least one network interface 340 and/or application interface 345. The application interface(s) 345 may support one or more APIs. The network interface(s) 340 may support 3GPP reference points, such as Uu and PC5. Other network interfaces 340 may be supported, as understood by one of ordinary skill in the art.

The processor 305, in one embodiment, may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325. In certain embodiments, the processor 305 may include an application processor (also known as “main processor”) which manages application-domain and operating system (“OS”) functions and a baseband processor (also known as “baseband radio processor”) which manages radio functions.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data related to reporting sensing beams and association with transmission beams for LBT. For example, the memory 310 may store parameters, configurations, resource assignments, policies, and the like as described above. In certain embodiments, the memory 310 also stores program code and related data, such as an operating system or other controller algorithms operating on the user equipment apparatus 300, and one or more software applications.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, is designed to output visual, audible, and/or haptic signals. In some embodiments, the output device 320 includes an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all or portions of the output device 320 may be integrated with the input device 315. For example, the input device 315 and output device 320 may form a touchscreen or similar touch-sensitive display. In other embodiments, the output device 320 may be located near the input device 315.

The transceiver 325 includes at least transmitter 330 and at least one receiver 335. The transceiver 325 may be used to provide UL communication signals to a base unit 121 and to receive DL communication signals from the base unit 121, as described herein. Similarly, the transceiver 325 may be used to transmit and receive SL signals (e.g., V2X communication), as described herein. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. In one embodiment, the transceiver 325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

In various embodiments, one or more transmitters 330 and/or one or more receivers 335 may be implemented and/or integrated into a single hardware component, such as a multi-transceiver chip, a system-on-a-chip, an ASIC, or other type of hardware component. In certain embodiments, one or more transmitters 330 and/or one or more receivers 335 may be implemented and/or integrated into a multi-chip module. In some embodiments, other components such as the network interface 340 or other hardware components/circuits may be integrated with any number of transmitters 330 and/or receivers 335 into a single chip. In such embodiment, the transmitters 330 and receivers 335 may be logically configured as a transceiver 325 that uses one more common control signals or as modular transmitters 330 and receivers 335 implemented in the same hardware chip or in a multi-chip module.

In one embodiment, the processor 305 is configured to report at least one UL transmission beam and at least one sensing beam that can be used to perform LBT prior to transmitting on the at least one UL transmission beam, according to a first configuration received from a network. In one embodiment, the processor 305 is configured to indicate a relationship between the reported at least one UL transmission beam and the reported at least one sensing beam via TCI, SRI, beam corresponding, or some combination thereof, according to a second configuration received from the network. In one embodiment, the processor 305 is configured to indicate a UL transmission beam via TCI, SRI, beam correspondence, or some combination thereof and determine a corresponding at least one sensing beam, based on the second configuration, to perform LBT, according to a third configuration received from the network.

In one embodiment, reporting the at least one sensing beam is activated or triggered separately from the reporting of the at least one UL transmission beam, according to the first configuration.

In one embodiment, the activation or triggering of reporting the at least one sensing beam is implicitly indicated such that it is assumed that whenever a new set of beams or TCI states for UL is activated by the network, for example via MAC CE activation.

In one embodiment, the activation or triggering of reporting the at least one sensing beam is explicitly indicated via a separate MAC CE activation, DCI indication, RRC indication, or some combination thereof to activate reporting of the sensing beams corresponding to each of the configured set of UL beams or TCI states.

In one embodiment, deactivation of reporting the at least one sensing beam is implicit in response to a number of reporting periods satisfying a predetermined threshold.

In one embodiment, the predetermined threshold is one.

In one embodiment, deactivation of reporting the at least one sensing beam is explicitly indicated via a separate MAC CE activation, DCI indication, RRC indication, or some combination thereof to deactivate reporting of the sensing beams corresponding to each of the configured set of UL beams or TCI states.

In one embodiment, the periodicity of reporting UL transmission beams and the periodicity of reporting corresponding sensing beams are different, the periodicity of reporting sensing beams being longer than the periodicity of reporting UL transmission beams, according to the first configuration.

In one embodiment, the sensing beams are quasi-co-located with type-D assumption with downlink reference signals, according to the first configuration.

In one embodiment, at least two sensing beams are reported for the at least one UL transmission beam, at least one of the two reported sensing beams being wider than the UL transmission beam, according to the first configuration.

In one embodiment, at least two sensing beams are reported for the at least one UL transmission beam, both of the two reported sensing beams being narrower than the UL transmission beam, according to the first configuration.

In one embodiment, the sensing beam is quasi-co-located with type-D assumption with the UL transmission beam in response to no sensing beam being reported to be configured and beam correspondence is supported.

FIG. 4 depicts one embodiment of a network apparatus 400 that may be used for reporting sensing beams and association with transmission beams for LBT, according to embodiments of the disclosure. In some embodiments, the network apparatus 400 may be one embodiment of a RAN node and its supporting hardware, such as the base unit 121 and/or gNB, described above. Furthermore, network apparatus 400 may include a processor 405, a memory 410, an input device 415, an output device 420, and a transceiver 425. In certain embodiments, the network apparatus 400 does not include any input device 415 and/or output device 420.

As depicted, the transceiver 425 includes at least one transmitter 430 and at least one receiver 435. Here, the transceiver 425 communicates with one or more remote units 105. Additionally, the transceiver 425 may support at least one network interface 440 and/or application interface 445. The application interface(s) 445 may support one or more APIs. The network interface(s) 440 may support 3GPP reference points, such as Uu, N1, N2, N3, N5, N6 and/or N7 interfaces. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a CPU, a GPU, an auxiliary processing unit, an FPGA, a DSP, a co-processor, an application-specific processor, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and OS functions and a baseband processor (also known as “baseband radio processor”) which manages radio function. In various embodiments, the processor 405 controls the network apparatus 400 to implement the above described network entity behaviors (e.g., of the gNB) for reporting sensing beams and association with transmission beams for LBT.

The memory 410, in one embodiment, is a computer readable storage medium. In some embodiments, the memory 410 includes volatile computer storage media. For example, the memory 410 may include a RAM, including DRAM, SDRAM, and/or SRAM. In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data relating to reporting sensing beams and association with transmission beams for LBT. For example, the memory 410 may store parameters, configurations, resource assignments, policies, and the like as described above. In certain embodiments, the memory 410 also stores program code and related data, such as an OS or other controller algorithms operating on the network apparatus 400, and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, may include any known electronically controllable display or display device. The output device 420 may be designed to output visual, audible, and/or haptic signals. In some embodiments, the output device 420 includes an electronic display capable of outputting visual data to a user. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, all or portions of the output device 420 may be located near the input device 415.

As discussed above, the transceiver 425 may communicate with one or more remote units and/or with one or more interworking functions that provide access to one or more PLMNs. The transceiver 425 may also communicate with one or more network functions (e.g., in the mobile core network 80). The transceiver 425 operates under the control of the processor 405 to transmit messages, data, and other signals and also to receive messages, data, and other signals. For example, the processor 405 may selectively activate the transceiver (or portions thereof) at particular times in order to send and receive messages.

The transceiver 425 may include one or more transmitters 430 and one or more receivers 435. In certain embodiments, the one or more transmitters 430 and/or the one or more receivers 435 may share transceiver hardware and/or circuitry. For example, the one or more transmitters 430 and/or the one or more receivers 435 may share antenna(s), antenna tuner(s), amplifier(s), filter(s), oscillator(s), mixer(s), modulator/demodulator(s), power supply, and the like. In one embodiment, the transceiver 425 implements multiple logical transceivers using different communication protocols or protocol stacks, while using common physical hardware.

In one embodiment, the processor 405 is configured to receive, from a UE, a report of at least one UL transmission beam and at least one sensing beam that can be used to perform LBT prior to transmitting on the at least one UL transmission beam, according to a first configuration. In one embodiment, the processor 405 is configured to receive, from the UE, an indication of a relationship between the reported at least one UL transmission beam and the reported at least one sensing beam via TCI, SRI, beam corresponding, or some combination thereof, according to a second configuration. In one embodiment, the processor 405 is configured to receive, from the UE, an indication of an UL transmission beam via TCI, SRI, beam correspondence, or some combination thereof and determine a corresponding at least one sensing beam, based on the second configuration, to perform LBT, according to a third configuration.

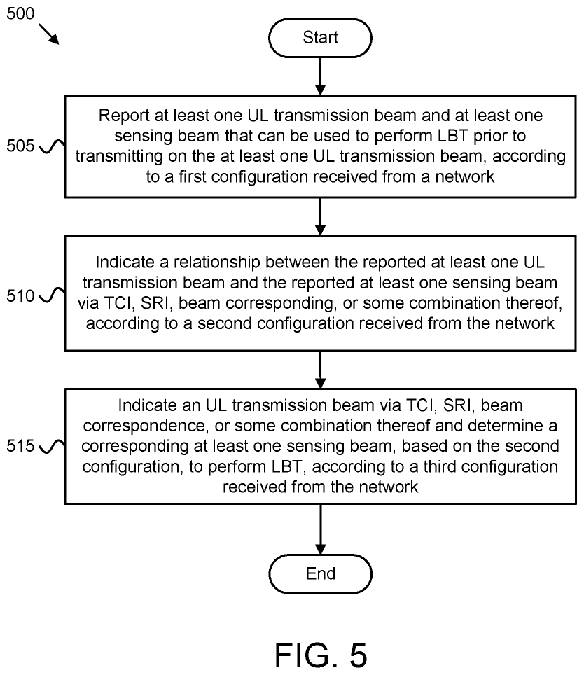

FIG. 5 is a flowchart diagram of a method 500 for reporting sensing beams and association with transmission beams for LBT. The method 500 may be performed by a UE as described herein, for example, the remote unit 105 and/or the user equipment apparatus 300. In some embodiments, the method 500 may be performed by a processor executing program code, for example, a microcontroller, a microprocessor, a CPU, a GPU, an auxiliary processing unit, a FPGA, or the like.

In one embodiment, the method 500 begins and reports 505 at least one UL transmission beam and at least one sensing beam that can be used to perform LBT prior to transmitting on the at least one UL transmission beam, according to a first configuration received from a network. In one embodiment, the method 500 indicates 510 a relationship between the reported at least one UL transmission beam and the reported at least one sensing beam via TCI, SRI, beam corresponding, or some combination thereof, according to a second configuration received from the network. In one embodiment, the method 500 indicates 515 an UL transmission beam via TCI, SRI, beam correspondence, or some combination thereof and determine a corresponding at least one sensing beam, based on the second configuration, to perform LBT, according to a third configuration received from the network, and the method 500 ends.

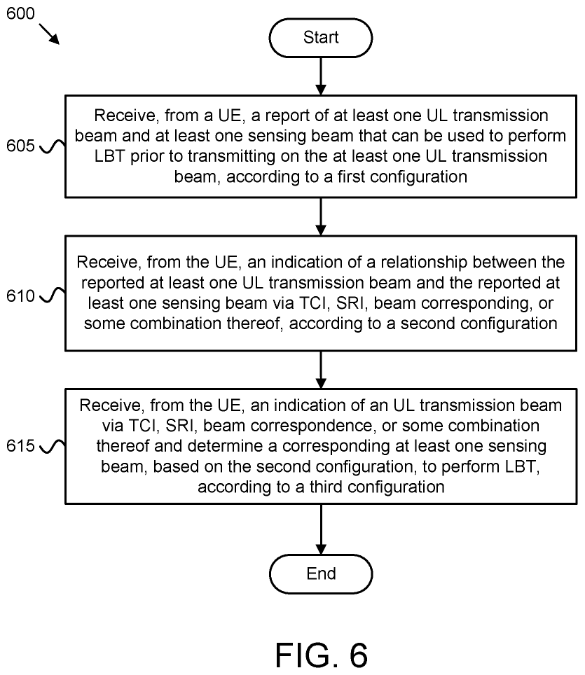

FIG. 6 is a flowchart diagram of a method 600 for receiving and processing a report including sensing beam(s) and association with transmission beam(s) for LBT. The method 600 may be performed by a network entity as described herein, for example, the base unit 121, the gNB, and/or the network equipment apparatus 400. In some embodiments, the method 600 may be performed by a processor executing program code, for example, a microcontroller, a microprocessor, a CPU, a GPU, an auxiliary processing unit, a FPGA, or the like.

In one embodiment, the method 600 begins and receives 605, from a UE, a report of at least one UL transmission beam and at least one sensing beam that can be used to perform LBT prior to transmitting on the at least one UL transmission beam, according to a first configuration. In one embodiment, the method 600 receives 610, from the UE, an indication of a relationship between the reported at least one UL transmission beam and the reported at least one sensing beam via TCI, SRI, beam corresponding, or some combination thereof, according to a second configuration. In one embodiment, the method 600 receives 615, from the UE, an indication of an UL transmission beam via TCI, SRI, beam correspondence, or some combination thereof and determine a corresponding at least one sensing beam, based on the second configuration, to perform LBT, according to a third configuration, and the method 600 ends.

A first apparatus is disclosed for reporting sensing beams and association with transmission beams for LBT. In one embodiment, the first apparatus may include a UE as described herein, for example, the remote unit 105 and/or the user equipment apparatus 300. In some embodiments, the first apparatus may include a processor executing program code, for example, a microcontroller, a microprocessor, a CPU, a GPU, an auxiliary processing unit, a FPGA, or the like.

In one embodiment, the first apparatus includes a processor and a memory coupled with the processor. In one embodiment, the processor is configured to cause the apparatus to report at least one UL transmission beam and at least one sensing beam that can be used to perform LBT prior to transmitting on the at least one UL transmission beam, according to a first configuration received from a network. In one embodiment, the processor is configured to cause the apparatus to indicate a relationship between the reported at least one UL transmission beam and the reported at least one sensing beam via TCI, SRI, beam corresponding, or some combination thereof, according to a second configuration received from the network. In one embodiment, the processor is configured to cause the apparatus to indicate a UL transmission beam via TCI, SRI, beam correspondence, or some combination thereof and determine a corresponding at least one sensing beam, based on the second configuration, to perform LBT, according to a third configuration received from the network.

In one embodiment, reporting the at least one sensing beam is activated or triggered separately from the reporting of the at least one UL transmission beam, according to the first configuration.

In one embodiment, the activation or triggering of reporting the at least one sensing beam is implicitly indicated such that it is assumed that whenever a new set of beams or TCI states for UL is activated by the network, for example via MAC CE activation.

In one embodiment, the activation or triggering of reporting the at least one sensing beam is explicitly indicated via a separate MAC CE activation, DCI indication, RRC indication, or some combination thereof to activate reporting of the sensing beams corresponding to each of the configured set of UL beams or TCI states.

In one embodiment, deactivation of reporting the at least one sensing beam is implicit in response to a number of reporting periods satisfying a predetermined threshold.

In one embodiment, the predetermined threshold is one.

In one embodiment, deactivation of reporting the at least one sensing beam is explicitly indicated via a separate MAC CE activation, DCI indication, RRC indication, or some combination thereof to deactivate reporting of the sensing beams corresponding to each of the configured set of UL beams or TCI states.

In one embodiment, the periodicity of reporting UL transmission beams and the periodicity of reporting corresponding sensing beams are different, the periodicity of reporting sensing beams being longer than the periodicity of reporting UL transmission beams, according to the first configuration.

In one embodiment, the sensing beams are quasi-co-located with type-D assumption with downlink reference signals, according to the first configuration.

In one embodiment, at least two sensing beams are reported for the at least one UL transmission beam, at least one of the two reported sensing beams being wider than the UL transmission beam, according to the first configuration.

In one embodiment, at least two sensing beams are reported for the at least one UL transmission beam, both of the two reported sensing beams being narrower than the UL transmission beam, according to the first configuration.

In one embodiment, the sensing beam is quasi-co-located with type-D assumption with the UL transmission beam in response to no sensing beam being reported to be configured and beam correspondence is supported at the apparatus.

In one embodiment, the sensing beam determination is based on the apparatus's implementation in response to no sensing beam being reported to be configured and no beam correspondence is supported at the apparatus.

A first method is disclosed for reporting sensing beams and association with transmission beams for LBT. The first method may be performed by a UE as described herein, for example, the remote unit 105 and/or the user equipment apparatus 300. In some embodiments, the first method may be performed by a processor executing program code, for example, a microcontroller, a microprocessor, a CPU, a GPU, an auxiliary processing unit, a FPGA, or the like.

In one embodiment, the first method reports at least one UL transmission beam and at least one sensing beam that can be used to perform LBT prior to transmitting on the at least one UL transmission beam, according to a first configuration received from a network. In one embodiment, the first method indicates a relationship between the reported at least one UL transmission beam and the reported at least one sensing beam via TCI, SRI, beam corresponding, or some combination thereof, according to a second configuration received from the network. In one embodiment, the first method indicates a UL transmission beam via TCI, SRI, beam correspondence, or some combination thereof and determine a corresponding at least one sensing beam, based on the second configuration, to perform LBT, according to a third configuration received from the network.

In one embodiment, reporting the at least one sensing beam is activated or triggered separately from the reporting of the at least one UL transmission beam, according to the first configuration.

In one embodiment, the activation or triggering of reporting the at least one sensing beam is implicitly indicated such that it is assumed that whenever a new set of beams or TCI states for UL is activated by the network, for example via MAC CE activation.

In one embodiment, the activation or triggering of reporting the at least one sensing beam is explicitly indicated via a separate MAC CE activation, DCI indication, RRC indication, or some combination thereof to activate reporting of the sensing beams corresponding to each of the configured set of UL beams or TCI states.

In one embodiment, deactivation of reporting the at least one sensing beam is implicit in response to a number of reporting periods satisfying a predetermined threshold.

In one embodiment, the predetermined threshold is one.

In one embodiment, deactivation of reporting the at least one sensing beam is explicitly indicated via a separate MAC CE activation, DCI indication, RRC indication, or some combination thereof to deactivate reporting of the sensing beams corresponding to each of the configured set of UL beams or TCI states.

In one embodiment, the periodicity of reporting UL transmission beams and the periodicity of reporting corresponding sensing beams are different, the periodicity of reporting sensing beams being longer than the periodicity of reporting UL transmission beams, according to the first configuration.

In one embodiment, the sensing beams are quasi-co-located with type-D assumption with downlink reference signals, according to the first configuration.

In one embodiment, at least two sensing beams are reported for the at least one UL transmission beam, at least one of the two reported sensing beams being wider than the UL transmission beam, according to the first configuration.

In one embodiment, at least two sensing beams are reported for the at least one UL transmission beam, both of the two reported sensing beams being narrower than the UL transmission beam, according to the first configuration.

In one embodiment, the sensing beam is quasi-co-located with type-D assumption with the UL transmission beam in response to no sensing beam being reported to be configured and beam correspondence is supported at the apparatus.

In one embodiment, the sensing beam determination is based on the apparatus's implementation in response to no sensing beam being reported to be configured and no beam correspondence is supported at the apparatus.

A second apparatus is disclosed for reporting sensing beams and association with transmission beams for LBT. The second apparatus may include a network entity as described herein, for example, the base unit 121, the gNB, and/or the network equipment apparatus 400. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor and a memory coupled with the processor. In one embodiment, the processor is configured to cause the apparatus to receive, from a UE, a report of at least one UL transmission beam and at least one sensing beam that can be used to perform LBT prior to transmitting on the at least one UL transmission beam, according to a first configuration. In one embodiment, the processor is configured to cause the apparatus to receive, from the UE, an indication of a relationship between the reported at least one UL transmission beam and the reported at least one sensing beam via TCI, SRI, beam corresponding, or some combination thereof, according to a second configuration. In one embodiment, the processor is configured to cause the apparatus to receive, from the UE, an indication of an UL transmission beam via TCI, SRI, beam correspondence, or some combination thereof and determine a corresponding at least one sensing beam, based on the second configuration, to perform LBT, according to a third configuration.

A second method is disclosed for reporting sensing beams and association with transmission beams for LBT. The second method may be performed by a network entity as described herein, for example, the base unit 121, the gNB, and/or the network equipment apparatus 400. In some embodiments, the second method may be performed by a processor executing program code, for example, a microcontroller, a microprocessor, a CPU, a GPU, an auxiliary processing unit, a FPGA, or the like.

In one embodiment, the second method receives, from a UE, a report of at least one UL transmission beam and at least one sensing beam that can be used to perform LBT prior to transmitting on the at least one UL transmission beam, according to a first configuration. In one embodiment, the second method receives, from the UE, an indication of a relationship between the reported at least one UL transmission beam and the reported at least one sensing beam via TCI, SRI, beam corresponding, or some combination thereof, according to a second configuration. In one embodiment, the second method receives, from the UE, an indication of an UL transmission beam via TCI, SRI, beam correspondence, or some combination thereof and determine a corresponding at least one sensing beam, based on the second configuration, to perform LBT, according to a third configuration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for wireless communication, comprising:
a processor; and
a memory coupled with the processor, the processor configured to cause the apparatus to:
report at least one uplink (“UL”) transmission beam and at least one sensing beam that can be used to perform listen-before-talk (“LBT”) prior to transmitting on the at least one UL transmission beam, according to a first configuration received from a network;
indicate a relationship between the reported at least one UL transmission beam and the reported at least one sensing beam via transmission configuration indication (“TCI”), sounding reference signal (“SRS”) resource indicator (“SRI”), beam corresponding, or some combination thereof, according to a second configuration received from the network; and
indicate a UL transmission beam via TCI, SRI, beam correspondence, or some combination thereof and determine a corresponding at least one sensing beam, based on the second configuration, to perform LBT, according to a third configuration received from the network.

2. The apparatus of claim 1, wherein reporting the at least one sensing beam is activated or triggered separately from the reporting of the at least one UL transmission beam, according to the first configuration.

3. The apparatus of claim 2, wherein the activation or triggering of reporting the at least one sensing beam is implicitly indicated such that it is assumed that whenever a new set of beams or TCI states for UL is activated by the network, for example via MAC CE activation.

4. The apparatus in claim 2, wherein the activation or triggering of reporting the at least one sensing beam is explicitly indicated via a separate medium access control-control element (“MAC CE”) activation, downlink control information (“DCI”) indication, radio resource control (“RRC”) indication, or some combination thereof to activate reporting of the sensing beams corresponding to each of the configured set of UL beams or TCI states.

5. The apparatus of claim 2, wherein deactivation of reporting the at least one sensing beam is implicit in response to a number of reporting periods satisfying a predetermined threshold.

6. The apparatus of claim 5, wherein the predetermined threshold is one.

7. The apparatus of claim 2, wherein deactivation of reporting the at least one sensing beam is explicitly indicated via a separate medium access control-control element (“MAC CE”) activation, downlink control information (“DCI”) indication, radio resource control (“RRC”) indication, or some combination thereof to deactivate reporting of the sensing beams corresponding to each of the configured set of UL beams or TCI states.

8. The apparatus of claim 1, wherein the periodicity of reporting UL transmission beams and the periodicity of reporting corresponding sensing beams are different, the periodicity of reporting sensing beams being longer than the periodicity of reporting UL transmission beams, according to the first configuration.

9. The apparatus of claim 1, wherein the sensing beams are quasi-co-located with type-D assumption with downlink reference signals, according to the first configuration.

10. The apparatus of claim 1, wherein at least two sensing beams are reported for the at least one UL transmission beam, at least one of the two reported sensing beams being wider than the UL transmission beam, according to the first configuration.

11. The apparatus of claim 1, wherein at least two sensing beams are reported for the at least one UL transmission beam, both of the two reported sensing beams being narrower than the UL transmission beam, according to the first configuration.

12. The apparatus of claim 1, wherein the sensing beam is quasi-co-located with type-D assumption with the UL transmission beam in response to no sensing beam being reported to be configured and beam correspondence is supported at the apparatus.

13. The apparatus of claim 1, wherein the sensing beam determination is based on the apparatus's implementation in response to no sensing beam being reported to be configured and no beam correspondence is supported at the apparatus.

14. A method for wireless communication, comprising:
reporting at least one uplink (“UL”) transmission beam and at least one sensing beam that can be used to perform listen-before-talk (“LBT”) prior to transmitting on the at least one UL transmission beam, according to a first configuration received from a network;
indicating a relationship between the reported at least one UL transmission beam and the reported at least one sensing beam via transmission configuration indication (“TCI”), sounding reference signal (“SRS”) resource indicator (“SRI”), beam corresponding, or some combination thereof, according to a second configuration received from the network; and
indicating an UL transmission beam via TCI, SRI, beam correspondence, or some combination thereof and determining a corresponding at least one sensing beam, based on the second configuration, to perform LBT, according to a third configuration received from the network.

15. An apparatus for wireless communication, comprising:
a processor; and
a memory coupled with the processor, the processor configured to cause the apparatus to:
receive, from a user equipment (“UE”), a report of at least one uplink (“UL”) transmission beam and at least one sensing beam that can be used to perform listen-before-talk (“LBT”) prior to transmitting on the at least one UL transmission beam, according to a first configuration;
receive, from the UE, an indication of a relationship between the reported at least one UL transmission beam and the reported at least one sensing beam via transmission configuration indication (“TCI”), sounding reference signal (“SRS”) resource indicator (“SRI”), beam corresponding, or some combination thereof, according to a second configuration; and
receive, from the UE, an indication of an UL transmission beam via TCI, SRI, beam correspondence, or some combination thereof and determine a corresponding at least one sensing beam, based on the second configuration, to perform LBT, according to a third configuration.
